(19) United States
(12) Patent Application Publication
(10) Pub. No.: US 2026/0175674 A1
(43) Pub. Date: Jun. 25, 2026

(54) VEHICLE BODY FRONT STRUCTURE

(71) Applicant: Honda Motor Co., Ltd., Tokyo (JP)

(72) Inventors: Junya HARADA, Tokyo (JP); Hayao MATSUTANI, Tokyo (JP); Shinjiro OZAWA, Tokyo (JP); Tadashi KUROTANI, Tokyo (JP)

(73) Assignee: Honda Motor Co., Ltd., Tokyo (JP)

(21) Appl. No.: 19/383,711

(22) Filed: Nov. 9, 2025

(30) Foreign Application Priority Data
Dec. 25, 2024 (CN) 202411924779.6

(51) Int. Cl. B60K 11/08

(52) U.S. Cl. CPC B60K 11/085

(57) ABSTRACT

A vehicle body front structure, capable of improving a cooling effect of a heat exchanger while maintaining an aesthetic appearance of a vehicle, and including: a grill having a grill opening portion that is open on a front side of the vehicle; a heat exchanger disposed on a rear side of the grill and performing heat exchange with air flowing toward the rear side through the grill opening portion; and a shutter device disposed between the grill and the heat exchanger and opening and closing a passage between the grill opening portion and the heat exchanger, wherein the shutter device is provided with a shutter opening portion, the shutter opening portion exposes a part of the passage when the shutter device is in a closed state, and the shutter opening portion is disposed at a position different from the grill opening portion in a front view of the vehicle.

### CROSS-REFERENCE TO RELATED APPLICATION

This application claims the priority benefit of China application serial no. 202411924779.6, filed on Dec. 25, 2024. The entirety of the above-mentioned patent application is hereby incorporated by reference herein and made a part of this specification.

### BACKGROUND

### Technical Field

The disclosure relates to a vehicle body structure, and more particularly to a vehicle body front structure.

### Description of Related Art

In the related art (for example, Japanese Laid-Open Patent Publication No. 2015-223905), a vehicle body front structure of a vehicle is provided with a shutter device on a front side. The shutter device is disposed between a grill and a heat exchanger and has a plurality of shutters capable of rotating in a horizontal direction. When the plurality of shutters rotate in the horizontal direction and are separated from each other, the shutter device exposes a passage between the grill and the heat exchanger, so that air flows through a space between the plurality of shutters to the heat exchanger. In contrast, when the plurality of shutters rotate in the horizontal direction and contact each other, the shutter device cuts off the passage between the grill and the heat exchanger, so that the air is blocked by the shutters and cannot flow to the heat exchanger. Thus, in a closed state of the shutter device, almost no air can flow to the heat exchanger, so that a cooling efficiency of the heat exchanger is low. In addition, even when an opening portion is provided on the shutter device, a user outside the vehicle may see the opening portion of the shutter device and a structure on a rear side thereof (that is, an inside of an engine compartment), causing a poor visual impression to the user. Therefore, it is necessary to improve the vehicle body front structure to achieve both a cooling effect of the heat exchanger and an aesthetic appearance of the vehicle.

### SUMMARY

The disclosure provides a vehicle body front structure capable of improving a cooling effect of a heat exchanger while maintaining an aesthetic appearance of a vehicle.

The disclosure provides a vehicle body front structure, including: a grill having a grill opening portion that is open on a front side of a vehicle; a heat exchanger disposed on a rear side of the grill and performing a heat exchange with an air flowing toward the rear side through the grill opening portion; and a shutter device disposed between the grill and the heat exchanger and opening and closing a passage between the grill opening portion and the heat exchanger. The shutter device is provided with a shutter opening portion, the shutter opening portion exposes a part of the passage when the shutter device is in a closed state, and the shutter opening portion is disposed at a position different from the grill opening portion in a front view of the vehicle.

In an embodiment of the disclosure, the shutter opening portion is formed such that a long side portion thereof extends in a horizontal direction, and the grill opening portion and the shutter opening portion are disposed at different positions in a height direction.

In an embodiment of the disclosure, the shutter opening portion is disposed at a position higher than the grill opening portion in the height direction.

In an embodiment of the disclosure, the shutter opening portion is, in a front view of the vehicle, disposed at a position overlapping a vehicle emblem on the front side of the vehicle in the height direction.

In an embodiment of the disclosure, a refrigerant inside the heat exchanger flows along a long side direction of the shutter opening portion.

In an embodiment of the disclosure, the vehicle body front structure further includes: an electric fan disposed on a front side or a rear side of the heat exchanger and increasing or decreasing an air volume of an air passing through the heat exchanger. A central portion of the electric fan is, in a front view of the vehicle, disposed at a position different from the shutter opening portion, and the electric fan increases a rotation speed in the closed state of the shutter device.

In an embodiment of the disclosure, the electric fan is controlled based on a temperature of the refrigerant and rotates when the temperature of the refrigerant reaches or exceeds a preset value.

Based on the above, in the vehicle body front structure of the disclosure, the shutter device opening and closing a passage between the grill opening portion and the heat exchanger is provided with the shutter opening portion, the shutter opening portion exposes a part of the passage in the closed state of the shutter device, and is, in a front view of the vehicle, disposed offset from the grill opening portion. Thus, even in the closed state of the shutter device, an air outside the vehicle is able to flow toward the heat exchanger through the grill opening portion and the shutter opening portion exposing the part of the passage, thereby improving a cooling effect of the heat exchanger in the vehicle body front structure in the closed state of the shutter device. In addition, in the closed state of the shutter device, a user outside the vehicle is not able to see the shutter opening portion that is offset and a structure on a rear side thereof through the grill opening portion, thereby making it possible to avoid that a provision of the shutter opening portion impairs an appearance of the vehicle body front structure. That is, the shutter opening portion does not cause a poor visual impression to the user. Accordingly, the vehicle body front structure of the disclosure is capable of improving the cooling effect of the heat exchanger while maintaining the aesthetic appearance of the vehicle.

To make the features and advantages of the disclosure more comprehensible, several embodiments accompanied with drawings are described in detail as follows.

### BRIEF DESCRIPTION OF THE DRAWINGS

FIG. 1 is a perspective schematic view of a vehicle to which a vehicle body front structure according to an embodiment of the disclosure is applied.

FIG. 2 is a front schematic view of the vehicle body front structure shown in FIG. 1.

FIG. 3 is a front schematic view of a shutter device used in the vehicle body front structure shown in FIG. 2.

FIG. 4 is a schematic cross-sectional view in a front-rear direction of the vehicle body front structure shown in FIG. 2.

FIG. 5 is a front schematic view of a heat exchanger used in the vehicle body front structure shown in FIG. 2.

### DESCRIPTION OF THE EMBODIMENTS

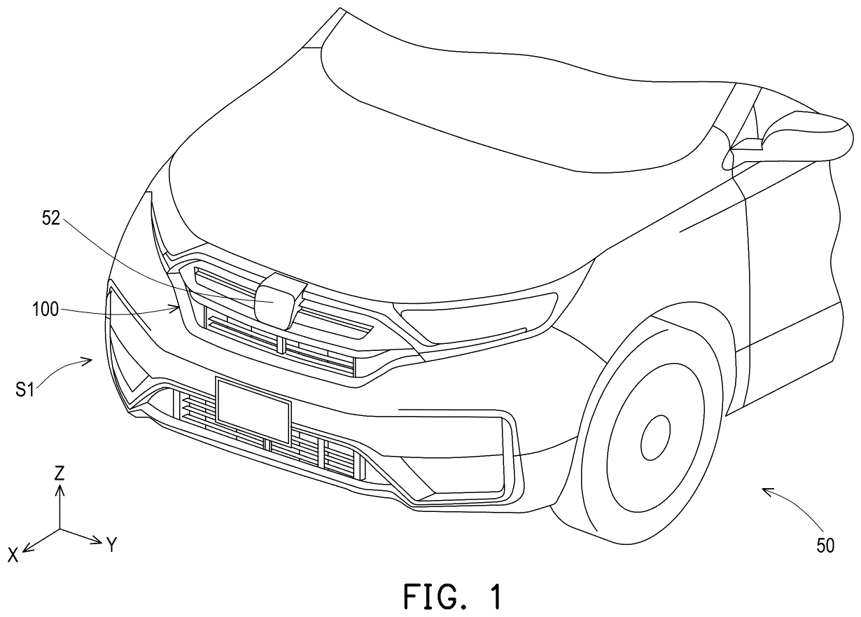

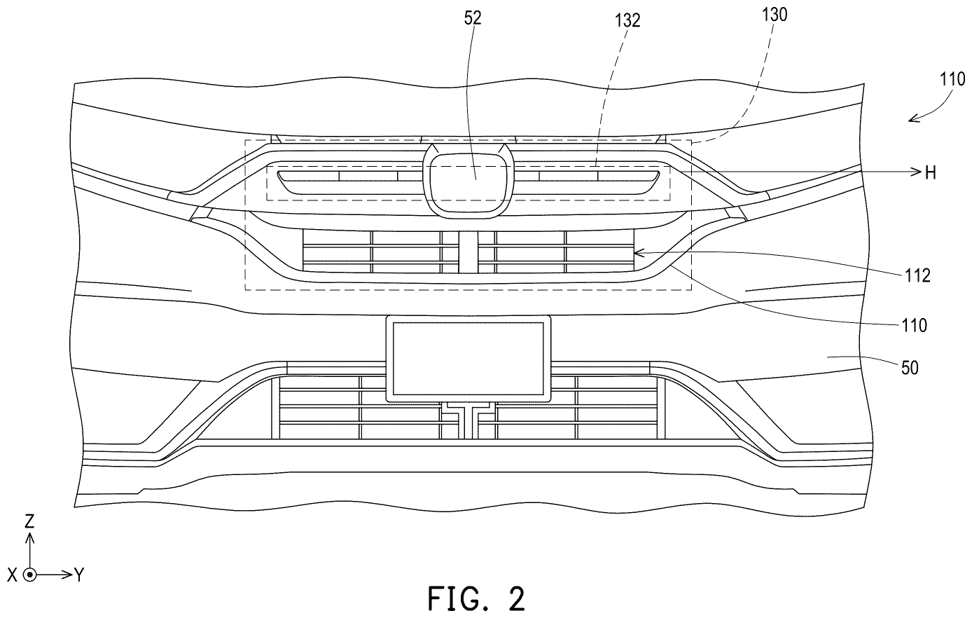

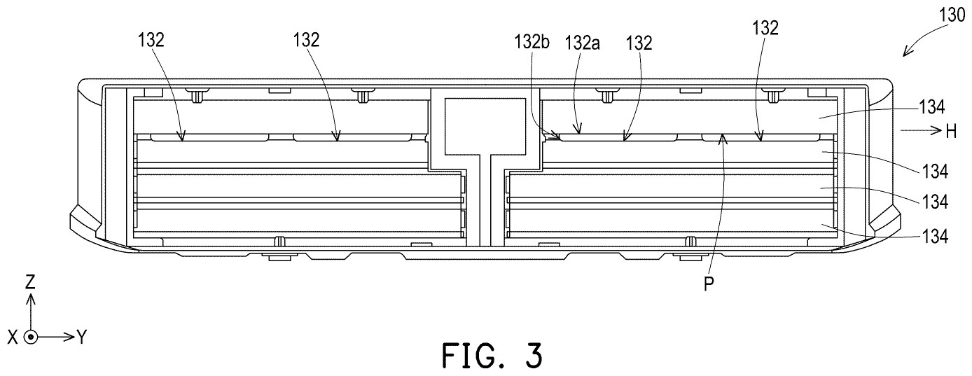

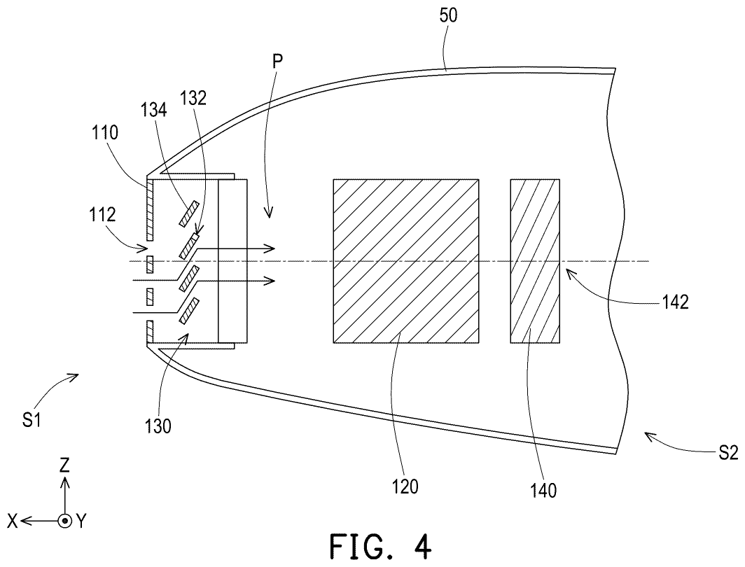

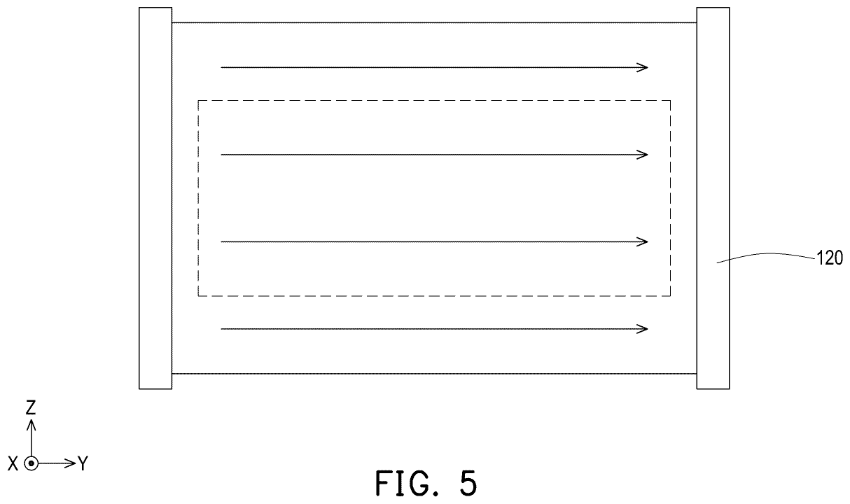

Exemplary embodiments of the disclosure will now be described in detail with reference to the accompanying drawings. Examples of the exemplary embodiments are illustrated in the drawings. FIG. 1 is a perspective schematic view of a vehicle to which a vehicle body front structure according to an embodiment of the disclosure is applied. FIG. 2 is a front schematic view of the vehicle body front structure shown in FIG. 1. FIG. 3 is a front schematic view of a shutter device used in the vehicle body front structure shown in FIG. 2. FIG. 4 is a schematic cross-sectional view in a front-rear direction of the vehicle body front structure shown in FIG. 2. FIG. 5 is a front schematic view of a heat exchanger used in the vehicle body front structure shown in FIG. 2. A specific structure and the like of a vehicle body front structure 100 of this embodiment will be described below with reference to FIGS. 1 to 5, but the disclosure is not limited thereto and may be adjusted as needed.

Please refer to FIGS. 1 to 4. In this embodiment, the vehicle body front structure 100 is, for example, a structure mounted on a front side S1 (that is, a side corresponding to a front side in a front-rear direction X) of a vehicle 50 and includes a grill 110, a heat exchanger 120, and a shutter device 130. The grill 110 has a grill opening portion 112 that is open on the front side S1 of the vehicle 50. The heat exchanger 120 is disposed on a rear side S2 (that is, a side corresponding to a rear side in the front-rear direction X) of the grill 110 and performs a heat exchange with an air flowing toward the rear side S2 through the grill opening portion 112 (as indicated by an arrow in FIG. 4). The shutter device 130 is disposed between the grill 110 and the heat exchanger 120 and opens and closes a passage P between the grill opening portion 112 and the heat exchanger 120. The shutter device 130 is provided with a shutter opening portion 132. The shutter opening portion 132 exposes a part of the passage P in a closed state of the shutter device 130 (a state as shown in FIG. 3) and is, in a front view of the vehicle 50 (that is, a view as shown in FIG. 2), disposed at a position different from the grill opening portion 112.

Specifically, in this embodiment, as shown in FIGS. 1 to 4, the grill 110, the shutter device 130, and the heat exchanger 120 are sequentially arranged in a front-rear direction X of the vehicle 50 from a front side S1 to a rear side S2. The grill 110 is provided with a grill opening portion 112 (for example, a plurality of grids arranged in an array as shown in FIG. 2), and an air outside the vehicle 50 (for example, on the front side S1) is able to flow toward the heat exchanger 120 on the rear side S2 through the grill opening portion 112 on the front side S1 and perform a heat exchange. Furthermore, the shutter device 130 is disposed in a passage P between the grill 110 and the heat exchanger 120, and is, for example, a plurality of shutters 134 (four in this example) arranged in a height direction Z and capable of rotating in a horizontal direction H (for example, a direction on a horizontal plane composed of the front-rear direction X and a left-right direction Y, not limited to a direction parallel to the left-right direction Y) as shown in FIG. 3. Thus, when the plurality of shutters 134 rotate in the horizontal direction H and are separated from each other in the height direction Z (for example, rotated to be perpendicular to the height direction Z), the shutter device 130 exposes the passage P (that is, an open state), so that an air flowing from the grill opening portion 112 toward the rear side S2 flows to the heat exchanger 120 through a space between the plurality of shutters 134. In addition, an air volume is able to be controlled by adjusting a rotation angle of the plurality of shutters 134. In contrast, when the plurality of shutters 134 rotate in the horizontal direction H and contact each other in the height direction Z (for example, rotated to be parallel to the height direction Z) (a state as shown in FIG. 3), the shutter device 130 cuts off the passage P (that is, a closed state), so that the air flowing from the grill opening portion 112 toward the rear side S2 is blocked by the shutters 134.

In addition, in this embodiment, as shown in FIG. 3, at least one of the plurality of shutters 134 of the shutter device 130 is provided with a notch or an opening as the shutter opening portion 132. Thus, in a closed state of the shutter device 130, even when the shutter 134 provided with the notch or the opening as the shutter opening portion 132 is rotated and comes into contact with adjacent other shutters 134 in a height direction Z, the shutter opening portion 132 still remains in an open state (a state as shown in FIG. 3). That is, even when the plurality of shutters 134 come into contact with each other in the height direction Z and block most of an area of the passage P, the shutter opening portion 132 provided on at least one of the shutters 134 is able to expose a part of the passage P in the closed state of the shutter device 130 (a state as shown in FIG. 3). Thus, even in the closed state of the shutter device 130, an air outside the vehicle 50 (for example, on the front side S1) is able to flow toward the heat exchanger 120 on the rear side S2 through the grill opening portion 112 on the front side S1 and the shutter opening portion 132 (although an air volume is smaller than that in the open state). Meanwhile, the shutter opening portion 132 and the grill opening portion 112 are offset from each other in a front view of the vehicle 50 (that is, a view as shown in FIG. 2), so that an air having fluidity is able to flow toward the heat exchanger 120 through the grill opening portion 112 and the shutter opening portion 132 that are offset from each other without being restricted thereby, but a line of sight of a user outside the vehicle 50 is not able to see the offset shutter opening portion 132 through the grill opening portion 112. However, the disclosure does not limit specific structures of the grill 110, the heat exchanger 120, and the shutter device 130, and they may be adjusted as needed.

Through the above configuration, in the vehicle body front structure 100 of the embodiment, as shown in FIGS. 1 to 4, the shutter device 130 opening and closing the passage P between the grill opening portion 112 and the heat exchanger 120 is provided with the shutter opening portion 132, the shutter opening portion 132 exposes a part of the passage P in a closed state of the shutter device 130 and is disposed offset from the grill opening portion 112 in a front view of the vehicle 50. Thus, even in the closed state of the shutter device 130, an air outside the vehicle 50 is able to flow toward the heat exchanger 120 through the grill opening portion 112 and the shutter opening portion 132 exposing the part of the passage P, thereby improving a cooling effect of the heat exchanger 120 in the vehicle body front structure 100 in the closed state of the shutter device 130. In addition, in the closed state of the shutter device 130, a user outside the vehicle 50 is not able to see the shutter opening portion 132 that is offset and a structure on a rear side S2 thereof through the grill opening portion 112, thereby making it possible to avoid that a provision of the shutter opening portion 132 impairs an appearance of the vehicle body front structure 100. That is, a provision of the shutter opening portion 132 does not cause a poor visual impression to the user. Accordingly, the vehicle body front structure 100 is capable of improving the cooling effect of the heat exchanger 120 while maintaining the aesthetic appearance of the vehicle 50.

Further, in this embodiment, as shown in FIGS. 2 and 3, the shutter opening portion 132 is, for example, a substantially rectangular elongated notch formed by a pair of long side portions 132a and a pair of short side portions 132b that are connected alternately. The shutter opening portion 132 is formed such that the long side portion 132a thereof extends in a horizontal direction H. As an example, the plurality of shutters 134 of the shutter device 130 are formed of elongated plates, and a notch or an opening is provided on one of the shutters 134 (preferably, a shutter 134 on an upper side, in this example, a second shutter 134), thereby forming the shutter opening portion 132 (elongated notch) extending in the horizontal direction H. In addition, the grill opening portion 112 and the shutter opening portion 132 are disposed at different positions in a height direction Z. Preferably, the shutter opening portion 132 is disposed at a position higher than the grill opening portion 112 in the height direction Z. Alternatively, the shutter opening portion 132 is, in a front view of the vehicle 50 (a view as shown in FIG. 2), disposed at a position overlapping a vehicle emblem 52 on the front side S1 of the vehicle 50 in the height direction Z. For example, the grill opening portion 112 of the grill 110 is disposed on a lower side, and the shutter opening portion 132 of the shutter device 130 is disposed on an upper side. The vehicle emblem 52 disposed on the front side S1 is disposed on the upper side to avoid the grill opening portion 112 that is also disposed on the front side S1, so that the emblem 52 and the shutter opening portion 132 are both disposed on the upper side and overlap each other in the height direction Z.

Thus, in this embodiment, as shown in FIGS. 2 and 3, the shutter opening portion 132 and the grill opening portion 112 are offset in the height direction Z, and the shutter opening portion 132 is further disposed at a position higher than the grill opening portion 112 (for example, a position corresponding to the vehicle emblem 52 in the height direction Z). Thus, while maintaining a state in which the shutter opening portion 132 exposes a part of the passage P, the above-described structure blocks the shutter opening portion 132 in a front view, in particular, a user outside the vehicle 50 is not able to see the shutter opening portion 132 located higher than the grill opening portion 112 and a structure on a rear side S2 thereof through the grill opening portion 112, thereby making it possible to avoid that the shutter opening portion 132 impairs the appearance. As an example, the grill 110 and the shutter device 130 may be integrated into a single device. For example, the grill opening portion 112 may be provided on a front side S1 of a lower half of the grill 110, and the shutter opening portion 132 and the plurality of shutters 134 may be provided on a rear side S2 of an upper half thereof, so that a space required to provide the grill 110 and the shutter device 130 in the vehicle body front structure 100 can be saved (i.e., achieving a space saving effect). However, the disclosure does not limit a specific structure of the shutter opening portion 132 or a relative position of the shutter opening portion 132 and the grill opening portion 112 (as long as the two are offset from each other in a front view), and they may be adjusted as needed.

Furthermore, in this embodiment, as shown in FIG. 5, a refrigerant (not shown) is provided inside the heat exchanger 120 to perform the heat exchange by flowing inside the heat exchanger 120. For example, the refrigerant of the heat exchanger 120 absorbs heat energy generated inside the vehicle 50 on the rear side S2 and transfers the absorbed heat energy to an air flowing in from outside the vehicle 50 on the front side S1. Subsequently, the air having absorbed the heat energy is discharged to the outside through other parts of the vehicle 50, and the refrigerant having transferred and released the heat energy again absorbs the heat energy generated inside the vehicle 50 on the rear side S2, and repeats the cycle, thereby discharging the heat energy inside the vehicle 50 to the outside through heat exchange between the outside air and the heat exchanger 120. Here, the refrigerant inside the heat exchanger 120 flows (as indicated by the arrow in FIG. 5) along a long side direction of the shutter opening portion 132 (that is, an extending direction of the long side portion 132a, as shown in FIG. 3, which corresponds to the horizontal direction H in this case). That is, the refrigerant inside the heat exchanger 120 is able to perform the heat exchange over a large area in the long side direction of the shutter opening portion 132 with the air flowing to the rear side S2 through the shutter opening portion 132. Thus, even in the closed state of the shutter device 130, an air outside the vehicle 50 is able to more effectively flow toward the heat exchanger 120 through the shutter opening portion 132 for heat exchange, thereby improving a cooling effect of the heat exchanger 120 in the vehicle body front structure 100 in the closed state. However, the disclosure does not limit the heat exchange methods of the heat exchanger 120 (that is, does not limit a flow direction of the refrigerant and the like), and may be adjusted as needed.

In addition, in this embodiment, as shown in FIGS. 2 and 4, the vehicle body front structure 100 further includes an electric fan 140. The electric fan 140 is disposed on a front side S1 or a rear side S2 (in this case, the rear side S2 is taken as an example) of the heat exchanger 120 and increases or decreases an air volume of an air passing through the heat exchanger 120. That is, by rotating blades of the electric fan 140, an air outside the vehicle 50 (for example, on the front side S1) can be drawn toward the rear side S2 through the grill opening portion 112 and the shutter device 130. Thus, in an open state of the shutter device 130, the vehicle body front structure 100 is able to increase the air volume of the air flowing toward the rear side S2 through the open shutter device 130 by activating the electric fan 140, thereby improving a cooling efficiency of the heat exchanger 120. In contrast, in a closed state of the shutter device 130, the vehicle body front structure 100 is able to increase the air volume of the air flowing toward the rear side S2 through the shutter opening portion 132 of the shutter device 130 by activating the electric fan 140, thereby improving the cooling efficiency of the heat exchanger 120. However, in a case where the electric fan 140 is not provided, the air (for example, outside wind) is able to naturally flow into an inside of the vehicle 50, and the air (for example, traveling wind) can also more strongly flow into the inside of the vehicle 50 in a traveling state of the vehicle 50. The disclosure does not limit a specific structure, operation means, or presence or absence of the electric fan 140, and may be adjusted as needed.

Further, in this embodiment, as shown in FIG. 4, a central portion 142 of the electric fan 140 is, in a front view of the vehicle 50 (a view as shown in FIG. 2), disposed at a position different from the shutter opening portion 132 (for example, offset in a height direction Z as shown in FIG. 4), and the electric fan 140 increases a rotation speed in the closed state of the shutter device 130. The electric fan 140 is controlled based on a temperature of the refrigerant and rotates when the temperature of the refrigerant reaches or exceeds a preset value. Specifically, since the electric fan 140 is preferably aligned with the plurality of shutters 134 of the shutter device 130, the shutter opening portion 132 disposed at a position on an upper side of the shutter device 130 is offset from the central portion 142 of the electric fan 140 in the height direction Z in the front view. Thus, in the closed state of the shutter device 130, the vehicle body front structure 100 is able to increase an air volume of the air flowing toward the rear side S2 through the shutter opening portion 132 of the shutter device 130 by activating the electric fan 140. In particular, in a case where the air is transmitted only through the shutter opening portion 132 of the shutter device 130, it is preferable to increase the rotation speed of the electric fan 140 to increase the air volume and more effectively guide the air to a region not corresponding to the shutter opening portion 132 on the upper side, thereby further improving a cooling efficiency of the heat exchanger 120. In addition, whether to activate the electric fan 140 is controlled based on the temperature of the refrigerant, and the electric fan is activated only when the temperature of the refrigerant reaches or exceeds the preset value, thereby optimizing a control condition of the electric fan 140 and effectively cooling the refrigerant when the temperature of the refrigerant is too high. However, the disclosure is not limited thereto and may be adjusted as needed.

In summary, in the vehicle body front structure of the disclosure, the shutter device opening and closing a passage between the grill opening portion and the heat exchanger is provided with the shutter opening portion, the shutter opening portion exposes a part of the passage in the closed state of the shutter device and is disposed offset from the grill opening portion in a front view of the vehicle. Preferably, the grill opening portion and the shutter opening portion are disposed at different positions in a height direction (for example, the shutter opening portion is higher than the grill opening portion), so that the two are offset in the height direction. Thus, even in the closed state of the shutter device, an air outside the vehicle is able to flow toward the heat exchanger through the grill opening portion and the shutter opening portion exposing the part of the passage, thereby improving a cooling effect of the heat exchanger in the vehicle body front structure in the closed state of the shutter device. In addition, in the closed state of the shutter device, a user outside the vehicle is not able to see the shutter opening portion that is offset and a structure on a rear side thereof through the grill opening portion, thereby making it possible to avoid that a provision of the shutter opening portion impairs an appearance of the vehicle body front structure. That is, the shutter opening portion does not cause a poor visual impression to the user. Accordingly, the vehicle body front structure of the disclosure is capable of improving the cooling effect of the heat exchanger while maintaining the aesthetic appearance of the vehicle.

Finally, it should be noted that the above embodiments are only used to illustrate the technical solutions of the disclosure and are not intended to limit the disclosure. Although the disclosure has been described in detail with reference to the foregoing embodiments, those skilled in the art should understand that modifications may still be made to the technical solutions described in the foregoing embodiments, or some or all of the technical features may be replaced with equivalents. These modifications or replacements do not cause the essence of the corresponding technical solutions to deviate from the scope of the technical solutions in the embodiments of the disclosure.

What is claimed is:

1. A vehicle body front structure, comprising:
a grill having a grill opening portion that is open on a front side of a vehicle;
a heat exchanger disposed on a rear side of the grill and performing a heat exchange with an air flowing toward the rear side through the grill opening portion; and
a shutter device disposed between the grill and the heat exchanger and opening and closing a passage between the grill opening portion and the heat exchanger, wherein
the shutter device is provided with a shutter opening portion,
the shutter opening portion exposes a part of the passage when the shutter device is in a closed state, and the shutter opening portion is disposed at a position different from the grill opening portion in a front view of the vehicle.

2. The vehicle body front structure according to claim 1, wherein
the shutter opening portion is formed such that a long side portion thereof extends in a horizontal direction, and
the grill opening portion and the shutter opening portion are disposed at different positions in a height direction.

3. The vehicle body front structure according to claim 2, wherein
the shutter opening portion is disposed at a position higher than the grill opening portion in the height direction.

4. The vehicle body front structure according to claim 3, wherein
the shutter opening portion is, in a front view of the vehicle, disposed at a position overlapping a vehicle emblem on the front side of the vehicle in the height direction.

5. The vehicle body front structure according to claim 1, wherein
a refrigerant inside the heat exchanger flows along a long side direction of the shutter opening portion.

6. The vehicle body front structure according to claim 5, further comprising:
an electric fan disposed on a front side or a rear side of the heat exchanger and increasing or decreasing an air volume of an air passing through the heat exchanger, wherein
a central portion of the electric fan is, in a front view of the vehicle, disposed at a position different from the shutter opening portion, and
the electric fan increases a rotation speed in the closed state of the shutter device.

7. The vehicle body front structure according to claim 6, wherein
the electric fan is controlled based on a temperature of the refrigerant and rotates when the temperature of the refrigerant reaches or exceeds a preset value.
